(19) United States
(12) Patent Application Publication
(10) Pub. No.: US 2026/0367391 A1
(43) Pub. Date: Nov. 19, 2026

(54) NEAR-EYE DISPLAY DEVICE

(71) Applicant: YONGJIANG LABORATORY, Ningbo (CN)

(72) Inventors: Ye BI, Ningbo (CN); Chengrui LE, Ningbo (CN); Tianwen HOU, Ningbo (CN); Chaohao WANG, Ningbo (CN); Lei ZHAO, Ningbo (CN); Ze YUAN, Ningbo (CN)

(21) Appl. No.: 19/730,369

(22) Filed: Jul. 2, 2026

Related U.S. Application Data
(63) Continuation of application No. PCT/CN2024/131635, filed on Nov. 12, 2024.

(30) Foreign Application Priority Data
Jan. 8, 2024 (CN) 202410024809.1

(51) Int. Cl. G02B 27/00; G02B 3/00

(52) U.S. Cl. CPC G02B 27/0075; G02B 3/0037

(57) ABSTRACT

A near-eye display device, including: a tiled display screen (1); and an optical assembly (2) including a plurality of optical elements (21). A target optical element (21a) proximate to a tiling gap (10) in the tiled display screen (1) satisfies: a central point (E) of the tiling gap (10), a central point of the target optical element (21a) or a connection point (A) between two adjacent optical elements (21) in the target optical elements (21a), and a central point (B) of an eye-box region are collinear; and an element parameter of the target optical element (21a) is correlated with a dimension of the tiling gap (10).

### CROSS-REFERENCE TO RELATED APPLICATION

The present disclosure is a continuation of, and claims benefit of, International Application No. PCT/CN2024/131635, filed on Nov. 12, 2024, which claims priority to Chinese patent application No. 202410024809.1, filed on Jan. 8, 2024. The entire contents of each of the above-referenced patent applications are incorporated herein by reference.

### TECHNICAL FIELD

The present disclosure belongs to the field of display technology, and more particularly, relates to a near-eye display device.

### BACKGROUND

To improve the field of view (FOV) and resolution of a near-eye display device and provide a user with a wider field of view and higher image quality, a plurality of display screens are tiled by adopting tiled screen technology in the near-eye display device. A tiling gap exists between display screens tiled together. No pixels are displayed at the tiling gap. As a result, after the tiling gap is magnified by an optical element, a virtual image projected onto a virtual image plane is entirely black. Light rays of the virtual image enter the human eyes, resulting in a discontinuous image viewed by the user (namely a black shadow existing in the image viewed by the user, as shown in FIG. 1, which affects the user's immersion and visual experience.

### SUMMARY

The present disclosure aims to solve at least one of the technical problems in the related art. To this end, the present disclosure provides a near-eye display device, which can provide a continuous and complete image while improving the FOV, thereby enhancing the user's immersion and a resolution of the near-eye display device, and visual experience.

In a first aspect, the present disclosure provides a near-eye display device. The device includes: a tiled display screen including a plurality of display screens tiled together, a tiling gap being formed between two adjacent display screens of the plurality of display screens; and an optical assembly located at a light-emitting side of the tiled display screen, the optical assembly including a plurality of optical elements arranged in an array and connected to one another. A target optical element proximate to the tiling gap includes either: (i) one of the plurality of optical elements, wherein a central point of the tiling gap, a central point of the target optical element, and a central point of an eye-box region of the near-eye display device being collinear; or (ii) two adjacent optical elements of the plurality of optical elements, wherein the central point of the tiling gap, a connection point between the two adjacent optical elements, and the central point of the eye-box region being collinear, wherein at least one element parameter of the target optical element is correlated with a dimension of the tiling gap, and light rays of a virtual image generated by the tiling gap are incident outside the eye-box region of the near-eye display device.

According to the near-eye display device of the present disclosure, by disposing the tiled display screen, and disposing the optical assembly at the light-emitting side of the tiled display screen, more light rays of an image can enter human eyes, improving the FOV and the resolution of the near-eye display device. In addition, when the target optical element proximate to the tiling gap includes the one of the plurality of optical elements, the central point of the tiling gap, the central point of the target optical element, and the central point of the eye-box region are collinear. When the target optical element includes two adjacent optical elements of the plurality of optical elements, the central point of the tiling gap, the connection point between the two adjacent optical elements, and the central point of the eye-box region are collinear. In addition, the element parameter of the target optical element is correlated with the dimension of the tiling gap, such that light rays of the virtual image generated by the tiling gap are incident outside the eye-box region of the near-eye display device, preventing the virtual image generated by the tiling gap from entering human eyes, and providing the user with a continuous and complete image. Therefore, the user's immersion and visual experience can be enhanced.

According to an embodiment of the present disclosure, the element parameter of the target optical element includes a dimension of the target optical element, the dimension of the target optical element being correlated with the dimension of the tiling gap.

According to an embodiment of the present disclosure, the element parameter of the target optical element is correlated with the dimension of the tiling gap.

According to an embodiment of the present disclosure, the dimension of the target optical element is larger than the dimension of the tiling gap.

According to an embodiment of the present disclosure, the dimension of the target optical element is positively correlated with the dimension of the tiling gap.

According to an embodiment of the present disclosure, a dimension of the eye-box region is larger than a maximum dimension of a pupil.

According to an embodiment of the present disclosure, the element parameter of the target optical element includes a focal length. The focal length of the target optical element is fixed. Alternatively, the focal length of the target optical element is negatively correlated with the dimension of the tiling gap.

According to an embodiment of the present disclosure, element parameters of other optical elements of the plurality of optical elements in the optical assembly other than the target optical element are identical to or different from the element parameters of the target optical element.

According to an embodiment of the present disclosure, the tiled display screen includes any one of a flat display screen, a curved display screen, and a foldable display screen.

According to an embodiment of the present disclosure, the plurality of optical elements each includes a lens, the lens including any one of a spherical lens, an aspherical lens, and a free-form surface lens.

According to an embodiment of the present disclosure, the tiled display screen includes a gaze focus region and a peripheral region located outside the gaze focus region. A resolution of a display screen in the gaze focus region is higher than a resolution of a display screen in the peripheral region.

According to an embodiment of the present disclosure, the display screen in the gaze focus region is an OLED display screen. The display screen in the peripheral region comprises an LCD display screen.

According to an embodiment of the present disclosure, the peripheral region is located laterally and below the gaze focus region.

The one or more technical solutions described above in the embodiments of the present disclosure can provide at least one of the following technical effects.

By disposing the tiled display screen, and disposing the optical assembly at the light-emitting side of the tiled display screen, more light rays of the image enter human's eyes, improving the FOV and the resolution of the near-eye display device. In addition, when the target optical element proximate to the tiling gap includes the one of the plurality of optical elements, the central point of the tiling gap, the central point of the target optical element, and the central point of the eye-box region are collinear. When the target optical element includes two adjacent optical elements of the plurality of optical elements, the central point of the tiling gap, the connection point between the two adjacent optical elements, and the central point of the eye-box region are collinear. In addition, the element parameter of the target optical element is correlated with the dimension of the tiling gap, such that light rays of the virtual image generated by the tiling gap are incident outside the eye-box region of the near-eye display device, preventing the virtual image generated by the tiling gap from entering human eyes, and providing the user with the continuous and complete image. Therefore, the user's immersion and visual experience can be enhanced.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a first schematic diagram of an image in a near-eye display device in the related art.

FIG. 2 is a first schematic structural diagram of a near-eye display device according to an embodiment of the present disclosure.

FIG. 3 is a second schematic structural diagram of a near-eye display device according to an embodiment of the present disclosure.

FIG. 4 is a second schematic diagram of an image in a near-eye display device in the related art.

FIG. 5 is a third schematic diagram of an image in a near-eye display device in the related art.

FIG. 6 is a fourth schematic diagram of an image in a near-eye display device in the related art.

FIG. 7 is a fifth schematic diagram of an image in a near-eye display device in the related art.

FIG. 8 is a sixth schematic diagram of an image in a near-eye display device in the related art.

FIG. 9 is a schematic diagram of an image in a near-eye display device according to an embodiment of the present disclosure.

FIG. 10 is a schematic structural diagram of an optical assembly in a near-eye display device according to an embodiment of the present disclosure.

FIG. 11 is a third schematic structural diagram of a near-eye display device according to an embodiment of the present disclosure.

FIG. 12 is a fourth schematic structural diagram of a near-eye display device according to an embodiment of the present disclosure.

FIG. 13 is a schematic structural diagram of a tiled display screen in a near-eye display device according to an embodiment of the present disclosure.

FIG. 14 is a top view of a tiled display screen in a near-eye display device according to an embodiment of the present disclosure.

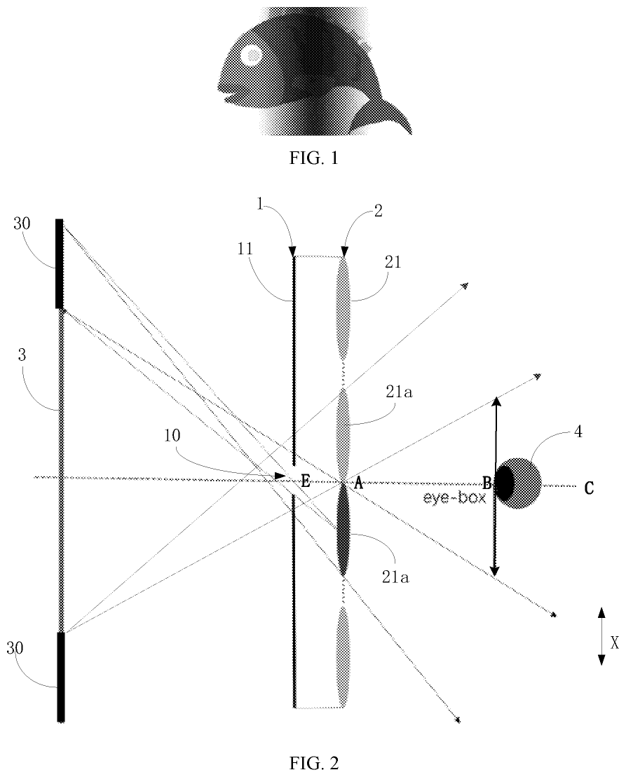

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative, and are intended to explain, rather than to limit the present disclosure.

A near-eye display device according to the embodiments of the present disclosure is described below with reference to the accompanying drawings.

FIG. 2 is a schematic structural diagram of a near-eye display device according to an embodiment of the present disclosure. The near-eye display device may include a virtual reality (VR) device or an augmented reality (AR) device, or the like.

As illustrated in FIG. 2, the near-eye display device includes a tiled display screen 1 and an optical assembly 2 located at a light-emitting side of the tiled display screen 1. The tiled d isplay screen 1 includes a plurality of display screens 11 tiled together. The dimensions of the plurality of display screens 11 may be the same or different. The dimension of the display screen may include a length, a width, and/or a display area of the display screen, or the like. Resolutions of the plurality of display screens 11 may be the same or different.

A tiling gap 10 is formed between two adjacent display screens of the plurality of display screens 11. The tiling gap 10 may refer to a gap between two adjacent display screens 11. Where each display screen 11 includes a display region and a non-display region, the tiling gap 10 may refer to a gap between the display regions of two adjacent display screens 11. No pixels are displayed at the tiling gap 10.

The optical assembly 2 includes a plurality of optical elements 21 arranged in an array and connected to one another. The plurality of optical elements 21 are configured to magnify an image displayed by the tiled display screen 1. The dimensions of the plurality of optical elements 21 may be the same or different. The overall dimension of the tiled display screen 1 may be larger than that of the optical assembly 2, and an orthographic projection of the optical assembly 2 onto the tiled display screen 1 may be located within the tiled display screen 1. The overall dimension of the tiled display screen 1 may be smaller than or equal to that of the optical assembly 2, and an orthographic projection of the tiled display screen 1 onto the optical assembly 2 may be located within the optical assembly 2, to ensure that all images displayed by the tiled display screen 1 can be magnified by the optical assembly 2.

At least one optical element 21 proximate to the tiling gap 10 is defined as a target optical element 21a. The target optical element 21a satisfies: the target optical element 21a includes one of the plurality of optical elements, a central point of the tiling gap 10, a central point of the target optical element 21a, and a central point of an eye-box region of the near-eye display device being collinear; or the target optical element 21a includes two adjacent optical elements of the plurality of optical elements, the central point of the tiling gap 10, a connection point between the two adjacent optical elements, and the central point of the eye-box region being collinear. In addition, an element parameter of the target optical element 21a is correlated with a dimension of the tiling gap 10, such that light rays of a virtual image 30 generated by the tiling gap 10 are incident outside the eye-box region of the near-eye display device.

The dimension of the tiling gap 10 includes a width of the tiling gap 10 along the first direction X, and the like. The element parameter of the target optical element 21a includes a dimension of the target optical element 21a (e.g., a width along the first direction X), and the like. The virtual image 30 generated by the tiling gap 10 refers to a virtual image 30 (black shadow) projected onto a virtual image plane 3 after the tiling gap 10 is magnified by the target optical element 21a. In optical design, an eye-box refers to a region where an observer's eyes can move relatively freely while still viewing a clear and correct image or field of view when observing or using an optical system. The eye-box is related to factors such as the field of view of the optical system, a line-of-sight focus, and a field curvature. For the optical system, especially the design of an observation device and a display device, it is required to ensure a good visual experience when the observer's eyes move slightly, without losing sharpness or developing other visual defects. For example, within an entire eye-box, brightness and contrast of a screen should be kept above a predetermined specific threshold to guarantee image quality. For another example, image distortion is strictly limited to an acceptable range to ensure that users do not experience an obvious degradation of image quality when shifting their line of sight. A definition of the eye-box in the present disclosure is not limited to specific forms of the above examples. The eye-box may be regarded as a virtual three-dimensional spatial region where the observer's eyes can move without compromising visual quality.

A positional relationship among the target optical element 21a, the tiling gap 10, and the eye-box region needs to meet predetermined requirements.

When the target optical element 21a includes one of the plurality of optical elements, a central point of the tiling gap 10, a central point of the target optical element 21a, and a central point of an eye-box region are collinear. The central point of the eye-box region is generally a position of the human eye (i.e., a central position of a pupil), such that the central point of the tiling gap 10, the central point of the target optical element 21a, and the position of the pupil are collinear.

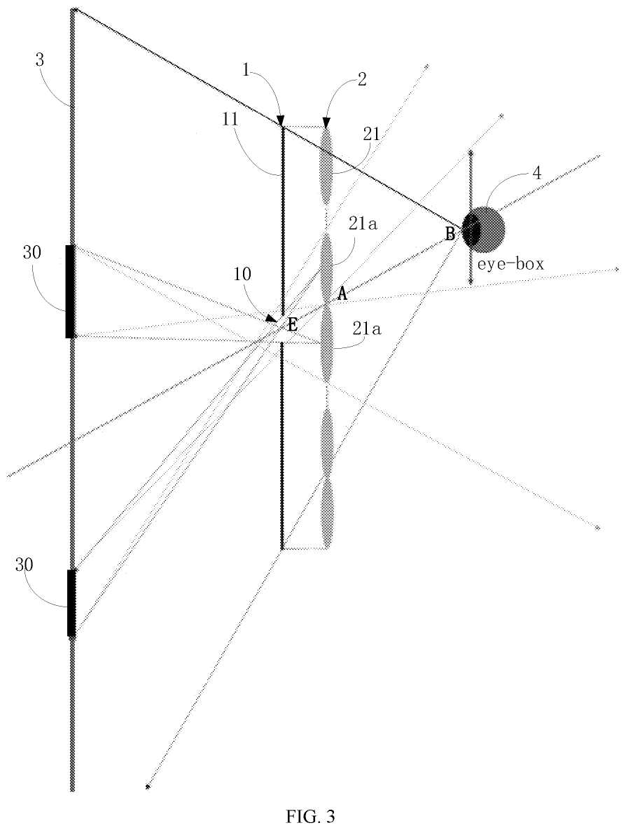

As illustrated in FIG. 2 and FIG. 3, when the target optical element includes two adjacent optical elements of the plurality of optical elements, a central point E of the tiling gap 10, a connection point A between the two adjacent optical elements, and a central point B of the eye-box region are collinear. The central point B of the eye-box region is generally the position of the human eye (i.e., the central position of the pupil), such that the central point E of the tiling gap 10, the connection point A between the adjacent two of the plurality of optical elements, and the position of the pupil are collinear.

The central point B of the eye-box region may or may not be located on a central axis C of the near-eye display device.

As illustrated in FIG. 2, when the central point B of the eye-box region is located on the central axis C of the near-eye display device, the central point E of the tiling gap 10 and the connection point A between the two adjacent optical elements in the target optical element 21a are located on the central axis C, such that the central point E of the tiling gap 10, the connection point A between the two adjacent optical elements, and the central point B of the eye-box region are collinear. The position of human eye 4 is located at the central point B of the eye-box region. In addition, the element parameters of the two adjacent optical elements are correlated with the dimension of the tiling gap 10, thereby ensuring that the virtual image 30 generated by the tiling gap 10 does not enter the human eye 4.

As illustrated in FIG. 3, when the central point B of the eye-box region is not located on the central axis C of the near-eye display device, the central point E of the tiling gap 10 and/or the connection point A between the two adjacent optical elements in the target optical element 21a may not be located on the central axis C. It is only necessary to ensure that the central point E of the tiling gap 10, the connection point A between the two adjacent optical elements, and the central point B of the eye-box region are collinear. The position of human eye 4 is located at the central point B of the eye-box region. In addition, the element parameters of the two adjacent optical elements are correlated with the dimension of the tiling gap 10, thereby ensuring that the virtual image 30 generated by the tiling gap 10 does not enter the human eye 4.

In this embodiment, by disposing the tiled display screen 1, and disposing the optical assembly 2 at the light-emitting side of the tiled display screen 1, the FOV of the near-eye display device can be enlarged, allowing the user to see a complete virtual environment to ensure the breadth of the virtual environment perceived by the user, and the resolution of the near-eye display device can be improved, allowing the user to see a clear image to ensure visual quality and sharpness. Although there are tiling gaps 10 between the tiled display screens 11 in the tiled display screen 1, and the virtual images 30 (black shadows) generated by the tiling gaps 10 may be projected onto the virtual image plane 3, by disposing the target optical element 21a, when the target optical element 21a includes one of the plurality of optical elements, the central point of the tiling gap 10, the central point of the target optical element 21a, and the central point of the eye-box region are collinear; and when the target optical element 21a includes two adjacent optical elements of the plurality of optical elements, the central point of the tiling gap 10, the connection point between the two adjacent optical elements, and the central point of the eye-box region are collinear; in addition, the element parameter of the target optical element 21a is correlated with the dimension of the tiling gap 10, such that light rays of the virtual image 30 generated by the tiling gap 10 are incident outside the eye-box region. Since the human eye moves within the eye-box region, the virtual image 30 cannot be viewed by the human eye 4, i.e., the user can see the continuous and complete image, thereby enhancing the user's immersion and visual experience.

In addition, in the related art, hardware tiling technology, software tiling technology, fusion technology, transparent display technology, or light field display technology are used to ensure image continuity. Among them, the hardware tiling technology uses a frame and a bracket to position and align multiple display screens to ensure seamless tiling of multiple display screens. The software tiling technology uses image processing software to process and merge images from multiple display screens, for example, by matching and correcting image pixel coordinates on different display screens to achieve image continuity. The fusion technology combines hardware and software methods to achieve optimized display of multiple display screens, including hardware tiling and correction, and further correction by image processing software. The transparent display technology uses a transparent display screen to achieve image fusion, reducing a visible gap between display screens. The light field display technology uses a complex optical design and image generation to provide continuous images from different viewing angles and positions, reducing an image difference on the tiled display screen and improving visual consistency. However, these methods require more advanced computer hardware to process image tiling, resulting in a high hardware cost, and thus limiting large-scale popularization. In addition, a computational burden can be increased, increasing system complexity.

With regard to the problem in the related art that light rays of the virtual image generated by the tiling gap are incident on the human eye, causing the discontinuous image seen by the user, the present embodiment ensures that the user can see the continuous and complete image by optimizing an optical design and an imaging mode of the optical assembly 2. Compared with the related arts that use hardware tiling technology, software tiling technology, fusion technology, transparent display technology, or light field display technology to ensure the image continuity, the present embodiment ensures that the user can see the continuous and complete image based on the optical design and the imaging mode of the optical assembly 2, without a need for more advanced computer hardware to process image tiling, without an increase of the computational burden, simplifying the system complexity. In addition, a hardware cost can be reduced, which is conducive to the large-scale application of the device.

In some embodiments, the element parameter of the target optical element 21a includes a dimension of the target optical element 21a. The dimension of the target optical element 21a may be a width of the target optical element 21a along the first direction X. The dimension of the target optical element 21a is correlated with the dimension of the tiling gap 10. That is, the dimension of the target optical element 21a may be designed according to the dimension of the tiling gap 10.

In some embodiments, the dimension of the target optical element 21a is larger than the dimension of the tiling gap 10. When the positional relationship among the target optical element 21a, the tiling gap 10, and the eye-box region meets predetermined requirements, the dimension of the target optical element 21a is larger than the dimension of the tiling gap 10. In addition, the dimension of the target optical element 21a is correlated with the dimension of the tiling gap 10, which can further ensure that the user views the continuous and complete image, thereby further enhancing the user's immersion and visual experience.

The dimension of the target optical element 21a is positively correlated with the dimension of the tiling gap 10. That is, the larger the dimension of the tiling gap 10, the larger the dimension of the target optical element 21a. The smaller the dimension of the tiling gap 10, the smaller the dimension of the target optical element 21a.

The dimensions of tiling gaps 10 between different display screens 11 are different. The dimension of the target optical element 21a proximate to the tiling gap 10 is set according to the dimension of the tiling gap 10. For example, when the dimension of the tiling gap 10 is fixed, gradually increasing the dimension of the target optical element 21a causes the virtual image 30 projected onto the virtual image plane 3 after the tiling gap 10 is magnified by the target optical element 21a to gradually move towards an outer side of the virtual image plane 3, until the light rays of the virtual image 30 are incident outside the eye-box region of the near-eye display device. That is, the light rays of the virtual image 30 cannot enter the human eye 4. Therefore, the target optical element 21a can be designed according to a dimension of the target optical element 21a when the light rays of the virtual image 30 cannot enter the human eye, thereby ensuring that images on different display screens 11 can be seamlessly presented to the user.

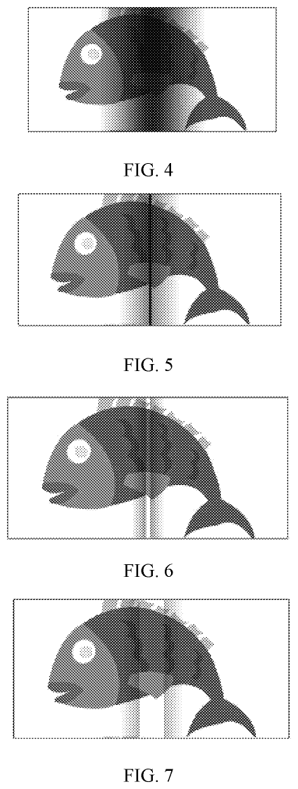

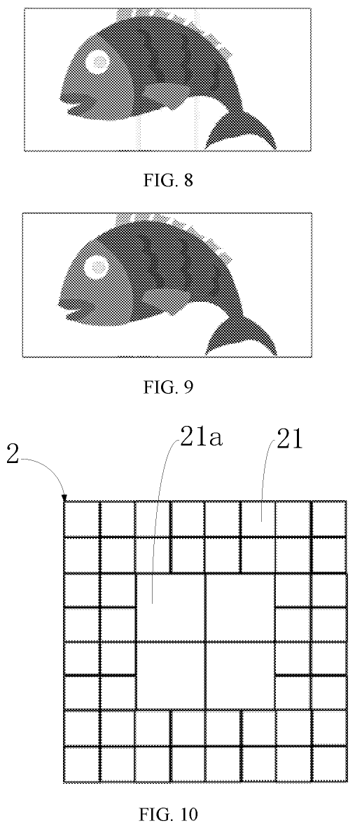

For example, a dimension of a tiling gap 10 between two adjacent display screens 11 is 4 mm. When the dimension of the target optical element 21a is 3 mm, an image viewed by the user is shown in FIG. 4. When the dimension of the target optical element 21a is 4 mm, an image viewed by the user is shown in FIG. 5. When the dimension of the target optical element 21a is 4.5 mm, an image viewed by the user is shown in FIG. 6. When the dimension of the target optical element 21a is 5 mm, an image viewed by the user is shown in FIG. 7. When the dimension of the target optical element 21a is 5.5 mm, an image viewed by the user is shown in FIG. 8. When the dimension of the target optical element 21a is 6 mm, an image viewed by the user is shown in FIG. 9. It can be seen that the image shown in FIG. 9 is a continuous and complete image. That is, the image shown in FIG. 9 does not have the virtual image 30 (black shadow). Therefore, when the dimension of the tiling gap 10 between the two adjacent display screens 11 is 4 mm, the dimension of the target optical element 21a can be set to 6 mm to ensure that the user can see the continuous and complete image.

In some embodiments, a dimension of the eye-box region is larger than a maximum dimension of a pupil. The dimension of the eye-box region may be the width of the eye-box region along the first direction X.

When the positional relationship among the target optical element 21a, the tiling gap 10, and the eye-box region meets predetermined requirements, the dimension of the eye-box region is larger than the maximum dimension of the pupil. In addition, the dimension of the target optical element 21a is larger than the dimension of the tiling gap 10, and the dimension of the target optical element 21a is correlated with the dimension of the tiling gap 10 (e.g., in a positive correlation). Therefore, continuous focusing can be achieved during user operation, ensuring that the user can always see the continuous and complete image, thereby further enhancing the user's immersion and visual experience.

In some embodiments, the element parameter of the target optical element 21a may include a focal length. The focal length of the target optical element 21a can be fixed. Alternatively, the focal length of the target optical element 21a can be negatively correlated with the dimension of the tiling gap 10. That is, the larger the dimension of the tiling gap 10, the smaller the focal length of the target optical element 21a.

When the positional relationship among the target optical element 21a, the tiling gap 10, and the eye-box region satisfies predetermined requirements, the dimension of the target optical element 21a is larger than that of the tiling gap 10. In addition, the dimension of the target optical element 21a is positively correlated with the dimension of the tiling gap 10. The focal length of the target optical element 21a is negatively correlated with the dimension of the tiling gap 10, which can further ensure that the user can see the continuous and complete image, further enhancing the user's immersion and visual experience.

In some embodiments, the target optical element 21a may further include other optical elements, such as those proximate to the aforementioned one optical element or other optical elements proximate to the aforementioned two adjacent optical elements, which are not specifically limited herein.

In some embodiments, element parameters of other optical elements 21 of the plurality of optical elements 21 in the optical assembly 2 other than the target optical element 21a may be different from the element parameters of the target optical element 21a. In other words, the optical assembly 2 includes at least two types of optical elements 21 (the target optical element 21a and the other optical elements 21). Element parameters of the at least two types of optical elements 21 may be different.

When the element parameters include the dimension and the focal length, the target optical element 21a and the other optical elements 21 have the same dimension but different focal lengths; or different dimensions but the same focal length; or different dimensions and different focal lengths.

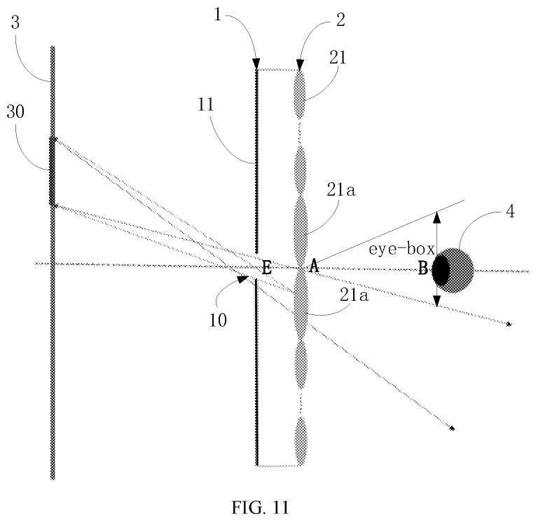

As illustrated in FIG. 10 and FIG. 11, four optical elements located at a central position of the optical assembly 2 (proximate to the tiling gap 10) are the target optical elements 21a. The dimension of the target optical element 21a is correlated with the dimension of the tiling gap 10. That is, the dimension of the target optical element 21a is positively correlated with the dimension of the tiling gap 10. The focal length of the target optical element 21a is fixed, or the focal length of the target optical element 21a is negatively correlated with the dimension of the tiling gap 10. The dimensions and focal lengths of the other optical elements 21 located at a peripheral side of the target optical element 21a are not correlated with the dimension of the tiling gap 10. The dimensions of the other optical elements 21 differ from those of the target optical elements 21a. For example, the dimensions of the other optical elements 21 may be smaller than those of the target optical elements 21a. The focal lengths of the other optical elements 21 may be the same as or different from those of the target optical elements 21a.

As illustrated in FIG. 11, the central point E of the tiling gap 10, the connection point A between the two adjacent optical elements in the target optical element 21a, and the central point B of the eye-box region are located on the central axis C. In addition, a dimension of each othf e two adjacent optical elements in the target optical element 21a is larger than the dimension of the tiling gap 10. The dimension of each of the two adjacent optical elements in the target optical element 21a is correlated with the dimension of the tiling gap 10, such that light rays of the virtual image 30 generated by the tiling gap 10 are incident outside the eye-box region, thereby preventing the virtual image 30 from entering the human eye 4.

In some embodiments, element parameters of other optical elements 21 in the optical assembly 2 other than the target optical element 21a may be identical to the element parameters of the target optical element 21a. In other words, the optical assembly 2 may include only one type of optical element 21. All optical elements 21 in the optical assembly 2 have the same element parameters.

When the element parameters include the dimension and the focal length, a dimension and a focal length of each optical element 21 in the optical assembly 2 are the same.

As illustrated in FIG. 3, the dimension of each optical element 21 in the optical assembly 2 is correlated with the dimension of the tiling gap 10. For example, the dimension of each optical element 21 is positively correlated with the dimension of the tiling gap 10. The focal length of each optical element 21 is fixed. Alternatively, the focal length of each optical element 21 is negatively correlated with the dimension of the tiling gap 10.

In some embodiments, an overall size W of the image on the virtual image plane 3 in the FOV field is given by: W=Ws(de+f+do)/de, where Ws is an overall dimension of the tiled display screen 1, de is an eye-relief, f is a focal length of the optical element 21, and do is an imaging distance.

In some embodiments, a relationship among an eye-box range (i.e., a dimension of the eye-box region) we, a dimension gap of the tiling gap 10, a dimension wl and a focal length f of the target optical element 21a is expressed as: eye-box we=(wl−gap)de/f. Moreover, the dimension wl of the target optical element 21a is greater than the dimension gap of the tiling gap 10, i.e., wl>gap.

The eye-box range we needs to be greater than the maximum dimension of the pupil (e.g., 8 mm). When the dimension gap of the tiling gap 10 is 2.7 mm, the dimension wl of the optical element 21 is 12.7 mm, the eye relief de is 20 mm, the focal length f is 5 mm, the FOV is 130°, and the eye-box we is 40 mm, which fully covers a movement range of the human eye.

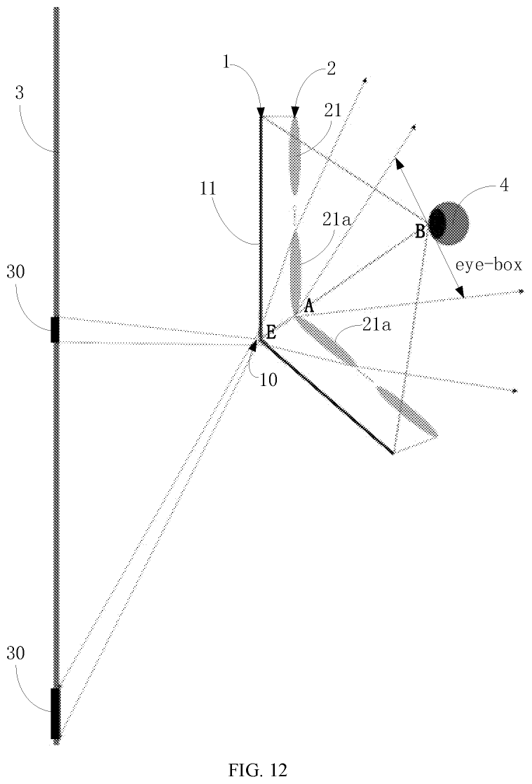

In some embodiments, the tiled display screen 1 includes any one of a flat display screen, a curved display screen, and a foldable display screen. When the tiled display screen 1 is the flat display screen, as illustrated in FIG. 2, FIG. 3, and FIG. 11, the optical assembly 2 is arranged in a planar configuration. That is, a plurality of optical elements 21 in the optical assembly 2 are distributed in a planar configuration. When the tiled display screen 1 is the curved display screen, the optical assembly 2 is arranged in a curved configuration. That is, the plurality of optical elements 21 in the optical assembly 2 are distributed in a curved arrangement. When the tiled display screen 1 is the foldable display screen, as illustrated in FIG. 12, the optical assembly 2 is configured to be foldable.

To further expand the field of view of the near-eye display device, the tiled display screen 1 may be the curved display screen or the foldable display screen. As illustrated in FIG. 12, for the curved display screen or the foldable display screen, the position of the human eye 4 is not on the central axis C. However, the central point E of the tiling gap 10, the connection point A between the two adjacent optical elements in the target optical element 21a, and the central point B of the eye-box (i.e., the position of the human eye 4) are collinear. In addition, a dimension of each of the two adjacent optical elements in the target optical element 21a is larger than the dimension of the tiling gap 10 and is correlated therewith. In this way, light rays of the virtual image 30 generated by the tiling gap 10 can be incident outside the eye-box, preventing the virtual image 30 from entering the human eye 4.

In some embodiments, the optical assembly 2 includes a lens array. The plurality of optical elements 21 each includes a lens. The lens includes any one of a spherical lens, an aspherical lens, and a free-form surface lens.

In this embodiment, different types of lens arrays may be selected according to specific application requirements. These different types of lens arrays meet the requirements of different application scenarios, improving flexibility of applications of the near-eye display device.

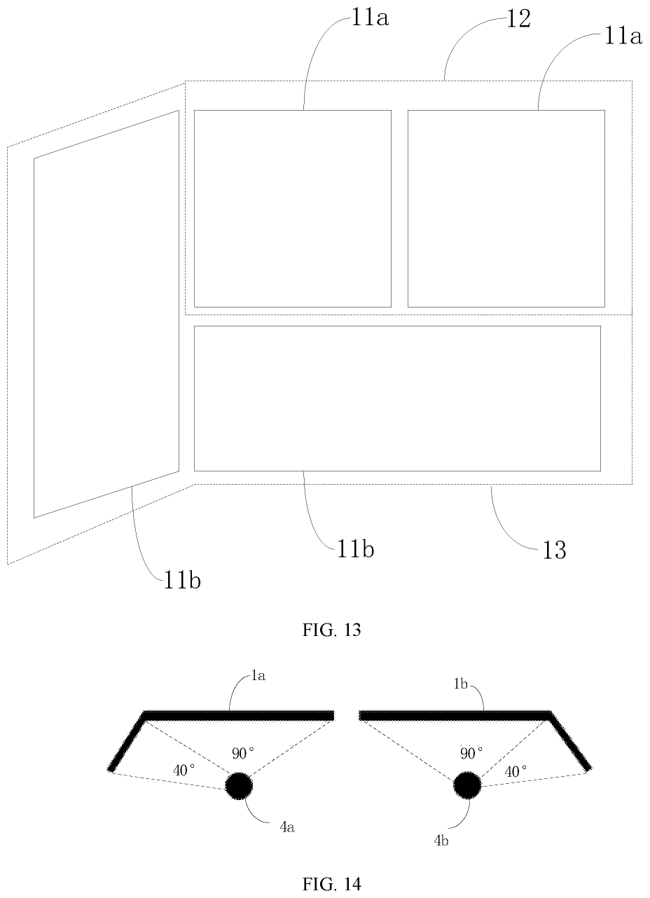

In some embodiments, as illustrated in FIG. 13, the tiled display screen 1 includes a gaze focus region 12 and a peripheral region 13 located outside the gaze focus region 12. The resolution of a display screen 11 in the gaze focus region 12 is higher than the resolution of a display screen 11 in the peripheral region 13.

The human visual perception varies across different regions of the field of view. That is, the human eye has different visual acuity requirements for different regions. Different types of display screens can be disposed in different regions according to a visual acuity requirement of each region, to provide a higher-quality visual experience while minimizing a cost. In the tiled display screen 1, a region corresponding to the central position of the human eye is the gaze focus region 12. A high-resolution display screen 11 may be disposed in the gaze focus region 12 to ensure that the user receives excellent image quality in the gaze focus region 12, which can help to improve the users' sense of immersion and realism. A low-resolution display screen 11 may be disposed in the peripheral region 13 to expand the FOV over a wider field of view, providing the user with a stronger sense of virtual environment.

A type and a number of display screens 11 in the gaze focus region 12 are not specifically limited, and a type and a number of display screens 11 in the peripheral region 13 are not specifically limited, which may be set and adjusted according to an actual application scenario and a user's need, to provide the user with a flexible virtual reality experience suitable for specific applications. The architecture of this embodiment allows for future scalability, enabling the upgrade of displays or the addition of more display screens as technology advances and market demands change, and ensuring that the device remains competitive in the future.

In some embodiments, the display screen 11 in the gaze focus region 12 includes an OLED display screen. The display screen 11 in the peripheral region 13 includes an LCD display screen. The OLED display screen may have a resolution of 4K. The LCD display screen may have a resolution of 2K.

The peripheral region 13 is located on at least one side of the gaze focus region 12. For example, the peripheral region 13 may be arranged around the gaze focus region 12. In some embodiments, the peripheral region 13 is located laterally and below the gaze focus region 12. As illustrated in FIG. 14, in a tiled display screen 1a corresponding to a left eye 4a, the peripheral region 13 is located on the left side and below the gaze focus region 12. In a tiled display screen 1b corresponding to a right eye 4b, the peripheral region 13 is located on the right side and below the gaze focus region 12.

In this embodiment, the tiling of display screens with various dimensions, pixel densities, and numbers can be realized to meet the needs of various application scenarios. For example, as illustrated in FIG. 13, the tiled display screen 1 includes two OLED display screens 11a with relatively small sizes but relatively high resolutions, and two LCD display screens 11b with relatively large sizes but relatively low resolutions. The two OLED display screens 11a are located at the central position of the human eye. That is, the two OLED display screens 11a are located in the gaze focus region 12, to ensure that the user receives a high-quality image in a key region of the field of view. Also, to expand an overall field of view (FOV) and minimize the cost, the two LCD display screens 11b are respectively located laterally and below the gaze focus region 12. As illustrated in FIG. 14, the FOV corresponding to each of the left eye 4a and the right eye 4b is 130°.

A resolution of each of the two OLED display screens 11a is 4K, and a resolution of each of the two LCD display screens 11b is 2K, achieving a resolution of 10K per eye to meet requirements of a high resolution and a large FOV.

The flexibility of this embodiment allows it to adapt to different usage scenarios and user needs. According to specific applications, a size and a configuration of each display screen 11 in the tiled display screen 1 may be adjusted to meet a need of a specific scenario. This flexibility provides the user with a customized virtual reality experience. This embodiment may be applied to various visual experience scenarios requiring the large FOV and the high resolution, such as simulation training, medical image processing, and scientific visualization.

After optical imaging, in this embodiment, image processing can be performed to further optimize image quality and continuity. In terms of software rendering, this embodiment adopts technologies such as image composition, correction and calibration, multi-channel rendering, and performance optimization. The image composition refers to the process of presenting a unified image on the plurality of display screens 11 usually requires image composition using software processing, including merging content from multiple image sources into a single, continuous image to adapt to an overall dimension of the tiled display screen 1. The correction and calibration refer to correcting differences in color, brightness, distortion, etc., between display screens 11 to ensure visual consistency. The multi-channel rendering refers to that to render multiple display screens 11 simultaneously, the software needs to be able to manage multiple rendering channels, effectively distribute a graphics rendering workload, and ensure that each channel operates synchronously. Software rendering requires performance optimization to ensure smooth image rendering at a high resolution and a high refresh rate a unified image on, which may involve graphics rendering techniques, multi-threaded rendering, and GPU acceleration.

In the near-eye display device according to the embodiments of the present disclosure, by disposing the tiled display screen and the optical assembly located at the light-emitting side of the tiled display screen, more light rays of the image can enter the human eyes, improving the FOV and the resolution, and thus enhancing the visual experience of the user. When the target optical element proximate to the tiling gap includes one of the plurality of optical elements, the central point of the tiling gap, the central point of the target optical element, and the central point of the eye-box region are collinear. When the target optical element includes two adjacent optical elements of the plurality of optical elements, the central point of the tiling gap, the connection point between the two adjacent optical elements, and the central point of the eye-box region are collinear. In addition, the element parameter of the target optical element is correlated with the dimension of the tiling gap, such that light rays of the virtual image generated by the tiling gap are incident outside the eye-box region, providing the user with the continuous and complete image. No higher computing power is required to handle issues arising from the tiling gap, which avoids increased computational demand, reduces the hardware cost, and simplifies the system complexity. Elimination of black shadows between images reduces visual fatigue and discomfort when the user uses the near-eye display device for a long time, further improving comfort of the virtual reality experience. By providing a high-resolution display screen in the gaze focus region and a low-resolution display screen in the peripheral region, higher visual quality can be achieved with a relatively low-cost hardware configuration. The device supports multiple types of tiled display screens and multiple types of lens arrays, providing greater flexibility and is applicable to different application scenarios.

Throughout the specification and claims of the present disclosure, terms such as “first” and “second” are used to distinguish similar objects, rather than to describe a particular order or sequence. It should be understood that numerical descriptors used in this way may be interchangeable where appropriate, to enable the embodiments of the present disclosure described herein to be implemented in an order other than that illustrated or described herein. Also, objects distinguished by the terms such as “first” and “second” are usually objects of the same type, and the quantity of the objects is not limited. For example, one or more first objects may be provided.

In the description of the present disclosure, the term “plurality/multiple” means two or more.

In the present disclosure, the description with reference to the terms “one embodiment”, “some embodiments”, “illustrative embodiments”, “an example”, “a specific example”, or “some examples”, etc., means that specific features, structures, materials, or characteristics described in conjunction with the embodiment(s) or example(s) are included in at least one embodiment or example of the present disclosure. The schematic representations of the aforementioned terms throughout this specification are not necessarily referring to the same embodiment or example. Further, the particular features, structures, materials, or characteristics described may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and concept of the present disclosure. The scope of the present disclosure shall be defined by the claims as appended and their equivalents.

What is claimed is:

1. A near-eye display device, comprising:
a tiled display screen comprising a plurality of display screens tiled together, wherein a tiling gap is formed between two adjacent display screens of the plurality of display screens; and
an optical assembly located at a light-emitting side of the tiled display screen, the optical assembly comprising a plurality of optical elements arranged in an array and connected to one another
wherein a target optical element proximate to the tiling gap comprises either:
(i) one of the plurality of optical elements, wherein a central point of the tiling gap, a central point of the target optical element, and a central point of an eye-box region of the near-eye display device are collinear; or
(ii) two adjacent optical elements of the plurality of optical elements, wherein a central point of the tiling gap, a connection point between the two adjacent optical elements, and the central point of the eye-box region are collinear; and
wherein at least one element parameter of the target optical element is correlated with a dimension of the tiling gap, and light rays of a virtual image generated by the tiling gap are incident outside the eye-box region.

2. The near-eye display device according to claim 1, wherein the element parameter of the target optical element comprises a dimension of the target optical element, the dimension of the target optical element being correlated with the dimension of the tiling gap.

3. The near-eye display device according to claim 2, wherein the dimension of the target optical element is larger than the dimension of the tiling gap.

4. The near-eye display device according to claim 3, wherein the dimension of the target optical element is positively correlated with the dimension of the tiling gap.

5. The near-eye display device according to claim 1, wherein a dimension of the eye-box region is larger than a maximum dimension of a pupil.

6. The near-eye display device according to claim 2, wherein a dimension of the eye-box region is larger than a maximum dimension of a pupil.

7. The near-eye display device according to claim 3, wherein a dimension of the eye-box region is larger than a maximum dimension of a pupil.

8. The near-eye display device according to claim 4, wherein a dimension of the eye-box region is larger than a maximum dimension of a pupil.

9. The near-eye display device according to claim 1, wherein the element parameter of the target optical element comprises a focal length, wherein:
the focal length of the target optical element is fixed; or
the focal length of the target optical element is negatively correlated with the dimension of the tiling gap.

10. The near-eye display device according to claim 2, wherein the element parameter of the target optical element comprises a focal length, wherein:
the focal length of the target optical element is fixed; or
the focal length of the target optical element is negatively correlated with the dimension of the tiling gap.

11. The near-eye display device according to claim 3, wherein the element parameter of the target optical element comprises a focal length, wherein:
the focal length of the target optical element is fixed; or
the focal length of the target optical element is negatively correlated with the dimension of the tiling gap.

12. The near-eye display device according to claim 4, wherein the element parameter of the target optical element comprises a focal length, wherein:
the focal length of the target optical element is fixed; or
the focal length of the target optical element is negatively correlated with the dimension of the tiling gap.

13. The near-eye display device according to claim 5, wherein the element parameter of the target optical element comprises a focal length, wherein:
the focal length of the target optical element is fixed; or
the focal length of the target optical element is negatively correlated with the dimension of the tiling gap.

14. The near-eye display device according to claim 1, wherein at least one of element parameters of other optical elements of the plurality of optical elements in the optical assembly other than the target optical element is identical to or different from the element parameters of the target optical element.

15. The near-eye display device according to claim 1, wherein the tiled display screen comprises any one of a flat display screen, a curved display screen, and a foldable display screen.

16. The near-eye display device according to claim 1, wherein the plurality of optical elements each comprises a lens, the lens comprising any one of a spherical lens, an aspherical lens, and a free-form surface lens.

17. The near-eye display device according to claim 1, wherein the tiled display screen comprises a gaze focus region and a peripheral region located outside the gaze focus region, wherein:
a resolution of a display screen in the gaze focus region is higher than a resolution of a display screen in the peripheral region.

18. The near-eye display device according to claim 17, wherein the display screen in the gaze focus region is an OLED display screen, and the display screen in the peripheral region comprises an LCD display screen.

19. The near-eye display device according to claim 17, wherein the peripheral region is located laterally and below the gaze focus region.

20. The near-eye display device according to claim 18, wherein the peripheral region is located laterally and below the gaze focus region.
